(19) United States
(12) Patent Application Publication
(10) Pub. No.: US 2013/0146739 A1
(43) Pub. Date: Jun. 13, 2013

(54) Portable kd umbrella base

(71) Applicant: Lifeng Zhao, Ningbo (CN)

(72) Inventor: Lifeng Zhao, Ningbo (CN)

(21) Appl. No.: 13/374,056

(22) Filed: Dec. 9, 2011

(51) Int. Cl. F16M 13/00

(52) U.S. Cl. 248/519

(57) ABSTRACT

An umbrella base comprises one or more identical sector-shaped base boxes that can be filled with heavy filling material (e.g., sand), the identical sector-shaped base boxes are attached to each other and placed on a formation of elongated base members of an umbrella to hold the umbrella in an upright position. When the umbrella base is not in use, the base boxes can be emptied and separated, and the identical sector-shaped boxes may be disassembled and stacked on top of one another. The overall dimension of the sector-shaped boxes when stacked is compact which allows the umbrella and the umbrella base together to fit inside the umbrella package.

### FIELD OF THE INVENTION

The present invention relates generally to umbrellas and relates more specifically to an umbrella base for maintaining an umbrella in an upright position.

### BACKGROUND OF THE INVENTION

Patio umbrellas are well known in which an umbrella canopy is mounted to a pole to provide shade for a deck, patio, garden, or the like. If the umbrella is of a tilting design, then whenever the umbrella canopy is tilted such that its center of gravity is no longer directly above the umbrella mount, considerable torque is be exerted on the mount and may tend to cause the umbrella to topple over. Even when the umbrella canopy is not tilted, breezes can exert forces on the umbrella canopy which tend to topple it. In the case of offset umbrellas, where the umbrella canopy is cantilevered out to the side of the pole, the torque exerted on the umbrella base by the dead weight of the umbrella canopy can be much higher, and must be higher on breezy days.

In applications where the umbrella will be used in only a single location, an umbrella base can be bolted to the underlying support structure, thus providing a sufficiently secure mount to resist such torque. However, in many applications it may be desirable to be able to move the umbrella around to various locations, or to be able to store the umbrella when not in use without an umbrella base being left in place. Such applications call for portable umbrella base. The portable umbrella base must be able to withstand the forces exerted by the umbrella without toppling, and without being anchored to the supporting substructure.

The majority of portable umbrella base rely on some form of weight down to the umbrella stand. Heavy objects such as concrete blocks or metal must be purchased separately and positioned on the umbrella stand to prevent the umbrella from toppling over.

The requirement for the weight presents a number of problems. First, the cost of shipping heavy weight makes it economically impractical to include the blocks along with the umbrella's package. In addition, commonly used forms of weight such as concrete or stone blocks will not fit within the typical umbrella package box, which is only designed to contain the umbrella in folding position. Also many stores which sell patio umbrellas may not sell the concrete blocks or other suitable objects to use as a supporting weight, meaning the purchaser must travel to another store after purchasing the umbrella in order to support it. In addition, there is the problem of the umbrella owner having to haul heavy blocks to the location where the umbrella will be used; the process may cause injury to the person. When it is desired to relocate the umbrella, the weight must again be moved.

Thus there is a need for a portable umbrella base with knockdown (KD) feature in which it allows the entire device can be shipped in the same shipping carton with the umbrella. Also there is a further need for an improved portable umbrella base which does not require the purchaser to make a trip to a store separate from the store where the umbrella is purchased in order to obtain suitable weights to support the umbrella base.

Further, there is a need for an improved portable umbrella base in which the umbrella purchaser does not have to carry heavy objects to the location where the umbrella will be set up. Hence it is desirable to use weight that can be gathered easily at many locations, such as to use sand or soil instead of concrete or stone blocks.

### SUMMARY OF THE INVENTION

As will be seen, the present invention overcomes these and other shortcomings associated with prior art umbrella bases. (U.S. Pat. Nos. 5,207,406; 5,354,031; 5,937,882; 6,446,930; 6,113,054; 6,367,494;) Stated generally, the present invention comprises an improved portable umbrella base with knockdown (KD) feature in which the entire device can be shipped in the same shipping carton with the umbrella. Thus there is no need for the umbrella purchaser to make a further trip to a store separate from the store where the umbrella is purchased in order to support the umbrella. Further, the umbrella owner does not have to drag the supporting weight for relocation, as well as the space required to store the base will be small due to its KD feature.

Stated more specifically, the present invention comprises one or more sector-shaped base boxes that can be attached to one another and filled with heavy filling material (e.g., sand), a formation of elongated base members attached to an umbrella holding pole, a base cover which can be disassembled to several sectors, a funnel. When the umbrella base is in use, heavy filling material is placed inside the sector-shaped base boxes which are then attached to each other and then placed on the formation of elongated base members.

In another embodiment, the base box comprises several identical Sector-shaped boxes. The sector-shaped boxes are further designed to have the top portion slightly larger than the bottom portion so that the sector-shaped boxes, when emptied, can be stacked on top of one another. One of the objects for such design is for the ease of transportation and storage.

In another embodiment, an interlocking mechanism links the sector-shaped boxes to form the base box. The bottom shape of the base box is designed to match the shape of the formation of elongated base members. It is further designed to have the elongated base members to lie under the mid section of the sector-shaped boxes. One of the objects for this design is to allow the weight of the heavy filling material to help the base box to grab on to the elongated base members.

Also, other objects, features, and advantages of the present invention will become apparent upon reading the following description, the accompany drawings and the appended claims.

### BRIEF DESCRIPTION OF THE DRAWINGS

FIG. 1 is a perspective view of an umbrella with the portable KD umbrella base.

FIG. 2 is a perspective view of the umbrella base boxes when it is disassembled.

FIG. 3 is a perspective view of the assembled portable KD umbrella base at horizontal angle.

FIG. 4 is a perspective view of the portable KD umbrella base before it is covered.

FIG. 5 is a perspective view of two sector-shaped base cover sections.

FIG. 6 is the base cover when it is assembled.

FIG. 7 is a perspective view of the sector-shaped box viewed from top.

FIG. 8 is a perspective view of the sector-shaped box viewed from bottom.

FIG. 9 is a perspective view of the sector-shaped boxes when stacked up.

FIG. 10 is a perspective view of two sector-shaped boxes being assembled.

FIG. 11 is a perspective view of sector-shaped boxes when they are assembled.

### DETAILED DESCRIPTION OF THE INVENTION

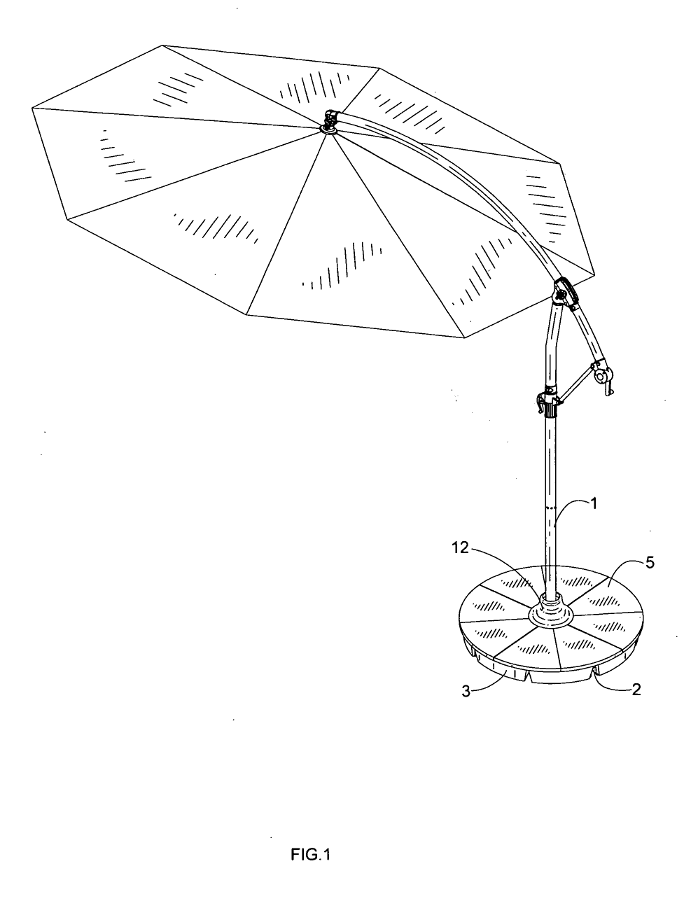

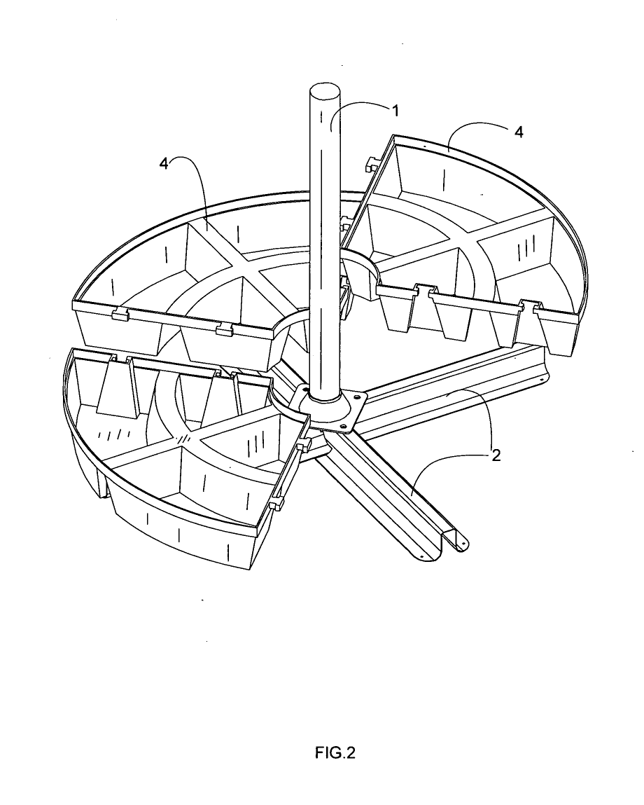

FIG. 1 shows in another embodiments where the umbrella comprises an umbrella holding pole 1, which is attached to a formation of elongated base members 2 (FIG. 2), and a base box 3 that is filled with heavy objects (e.g., sand) and placed on top of the base members 2. A cover 5 and a funnel 12 are placed on top of the base box 3.

FIG. 2 shows the umbrella holding pole 1, the base members 2, and several identical sector-shaped boxes 4, which are interlocked to form the base box 3 and placed on top of the base members 2.

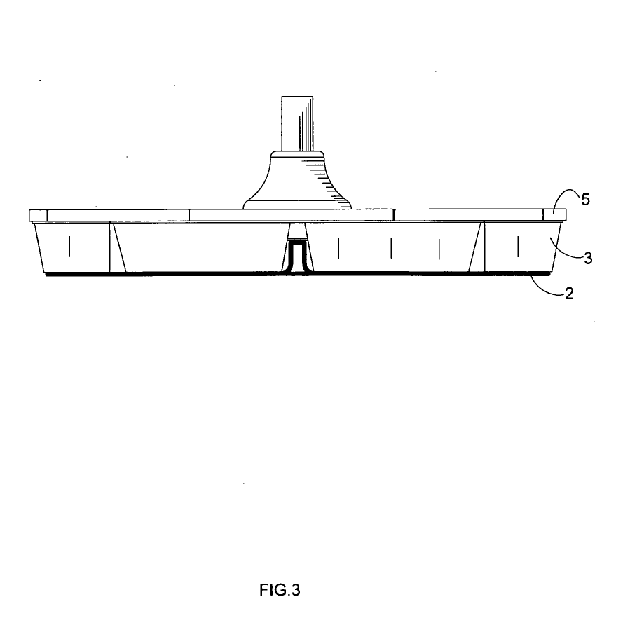

FIG. 3 shows the structure of the complete assembled base at horizontal view, the base cover 5 is placed on the base box 3, which comprises several of the sector-shaped boxes 4 that are attached to one another. Base box 3 with added weight into its cavity is placed on the base members 2, its weight acts on the flanges of the base members 2.

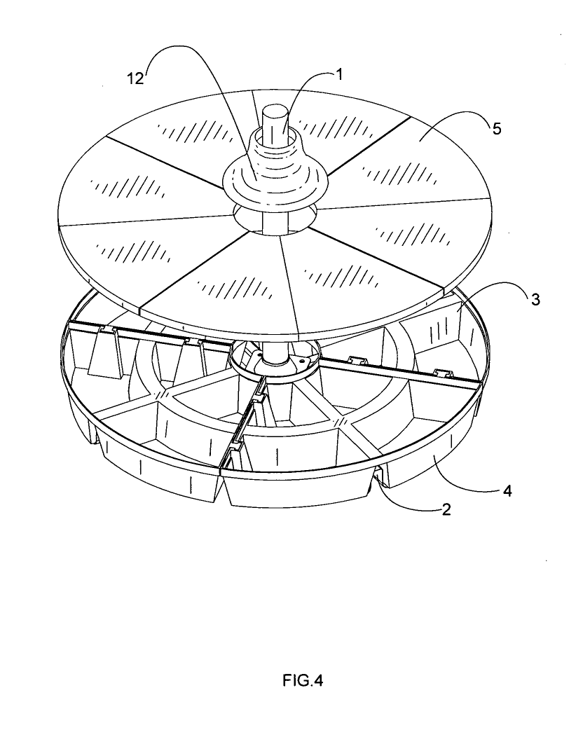

FIG. 4 shows the base box 3 on top of the base members 2 before a base cover 5 is placed on top of the base box 3. The base member 2 lies under the middle of each Sector-shaped box 4.

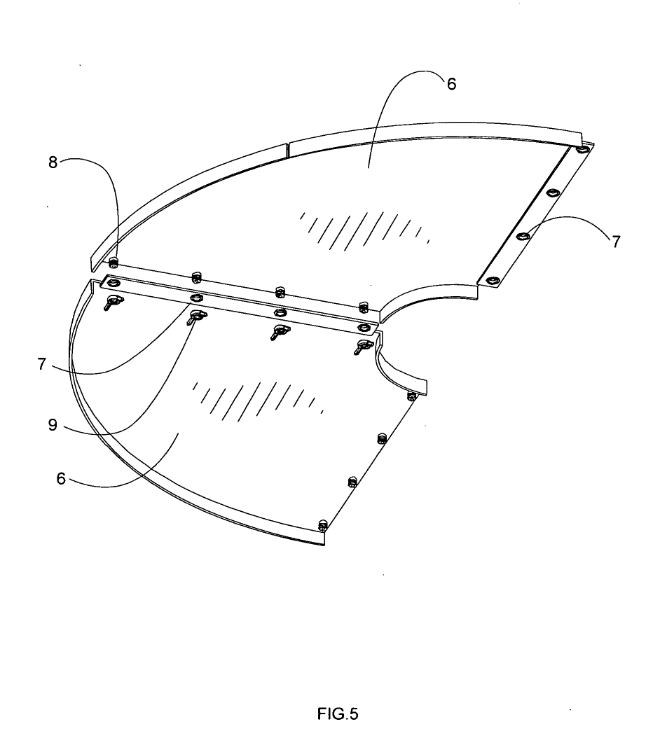

FIG. 5 shows the base cover 5 unassembled. One side of each sector-shaped base cover section 6 along the radius, a strip 7 with round holes is attached. Also along the radius, on the other side of each sector-shaped base cover section 6, threaded bolt members 8 are attached, corresponding to the location of the holes on the other side of the sector-shaped base cover section 6, so that nut members 9 can fasten the two sector-shaped base cover sections 6 together.

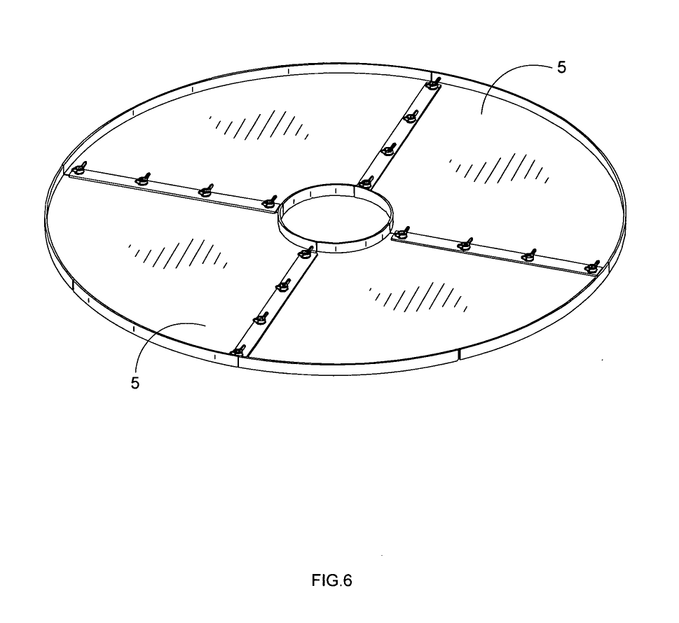

FIG. 6 shows the entire base cover 5 when assembled.

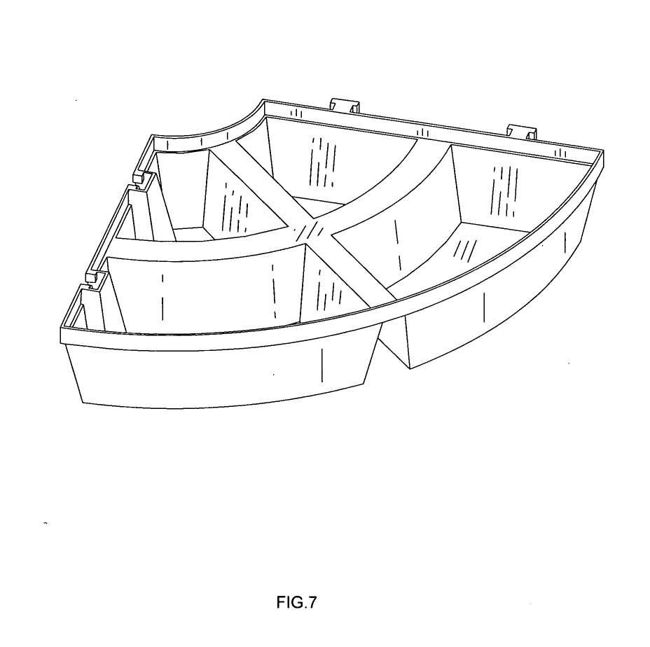

FIG. 7 shows the sector-shaped box 4 from top.

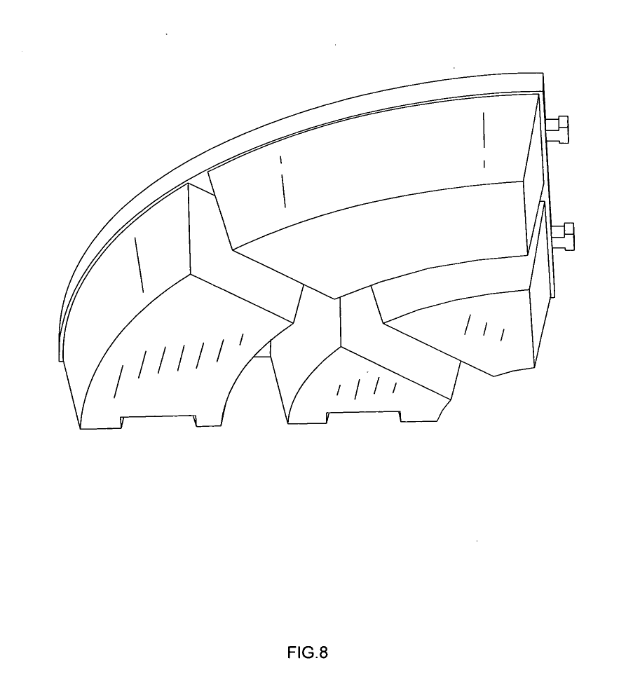

FIG. 8 shows the sector-shaped box 4 from bottom. Grooves are formed, matching the ridge and flange of the base members 2.

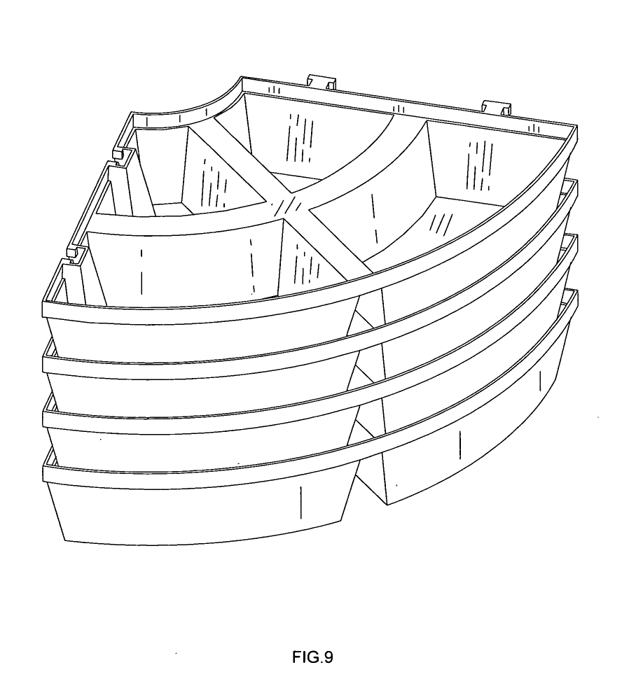

The sector-shaped boxes 4 are designed to have the top portion slightly larger than the bottom portion so that the sector-shaped boxes, when emptied, can be stacked on top of one another. FIG. 9 shows that the sector-shaped boxes 4 may be stacked.

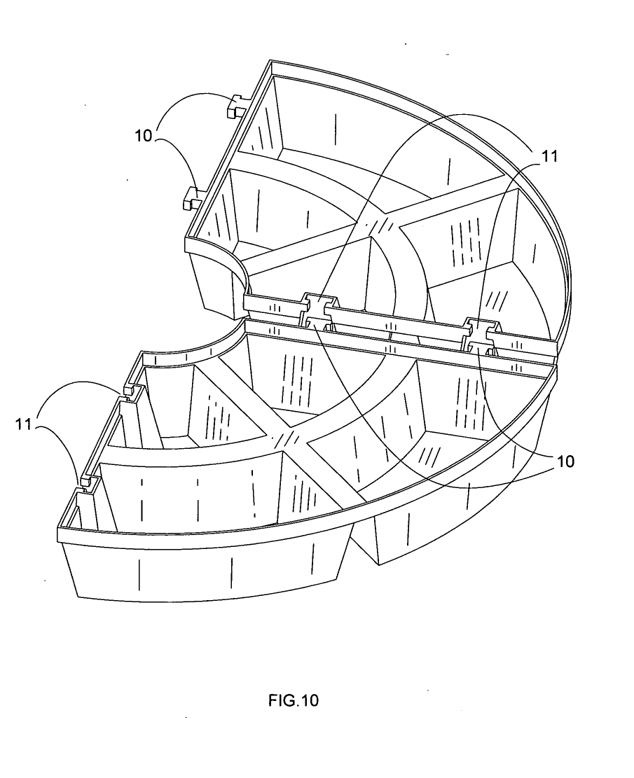

FIG. 10 shows how the sector-shaped boxes 4 are assembled to form the base box 3. Along the radius of one side of each sector-shaped box 4, several protruding members 10 fit the sockets 11 of the neighboring sector-shaped box 4. The locations of the sockets 11 correspond to the locations of the protruding members 10.

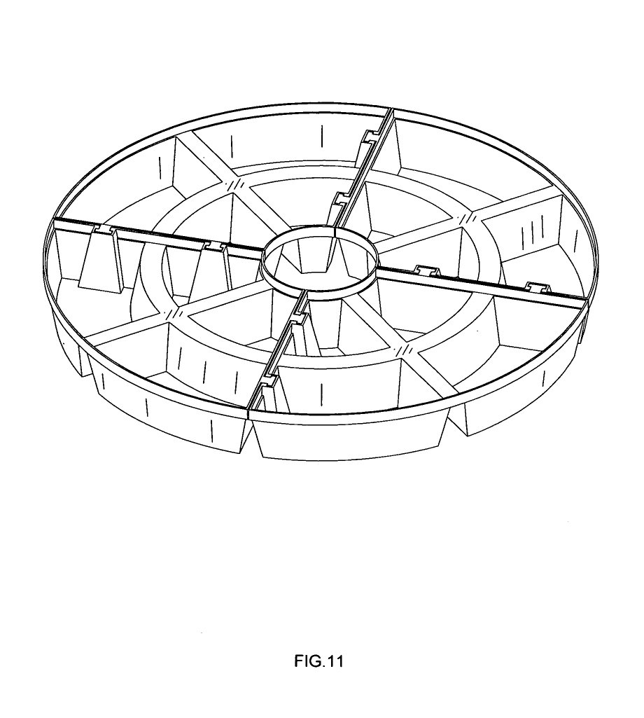

FIG. 11 shows the sector-shaped boxes 4 when assembled.

A ringlike cover 12 (FIG. 1 and FIG. 4) is placed on top of base cover 5. The umbrella holding pole 1 passes through the ringlike cover 12.

What we claimed is:

1. A portable KD umbrella base, comprising:
one or more base boxes define the cavities that are placed on top of an umbrella's base members;
a form of weight received within said cavities and comprised to the weight of the umbrella base;
whereby when a supporting pole of an umbrella is inserted into its holding pole and said umbrella is opened, said weight of the umbrella base weights down the formation of the elongated base members of said umbrella so as to maintain said umbrella in an upright condition.

2. The portable KD umbrella base of claim 1 wherein said base box comprises several identical sector-shaped boxes.

3. The portable KD umbrella base of claim 1 wherein the formation of the elongated base members of an umbrella lies under the middle of each said Sector-shaped boxes.

4. The portable KD umbrella base of claim 2 wherein each sector-shaped box is attached to the neighboring sector-shaped box.

5. The portable KD umbrella base of claim 2 wherein each sector-shaped box allows one to stack to the others.

6. The portable KD umbrella base of claim 2 wherein said sector-shaped boxes have grooves underneath matching the ridge and flange of said elongated base members.

7. The portable KD umbrella base of claim 1, further comprising a base cover.

8. The portable KD umbrella base of claim 7 wherein said base cover comprises several sector-shaped base cover sections.

9. The portable KD umbrella base of claim 8 wherein said sector-shaped base cover sections can be attached by fasten their corresponding bolt and nut members.
